(19) United States
(12) Patent Application Publication
(10) Pub. No.: US 2011/0128593 A1
(43) Pub. Date: Jun. 2, 2011

(54) IMAGE PROCESSING APPARATUS AND PROCESSING LIMITING METHOD

(75) Inventor: Masayoshi Karasawa, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/958,587

(22) Filed: Dec. 2, 2010

Related U.S. Application Data
(60) Provisional application No. 61/265,818, filed on Dec. 2, 2009.

(51) Int. Cl. H04N 1/04

(52) U.S. Cl. 358/474

(57) ABSTRACT

An image processing apparatus includes: an image scanning unit which scans an image of a document; a storage control unit which causes image data acquired by the image scanning unit scanning the image to be stored in a predetermined storage area; a limitation information associating unit which associates limitation information prescribing a limitation content for a processing content to be performed to the image data with the image data that is stored in the predetermined storage area, based on at least one of an image scanning condition in the image scanning unit and a content of the image data acquired by the image scanning unit; and a processing limiting unit which limits the content of processing performed to the image data stored in the predetermined storage area, based on the limitation information associated by the limitation information associating unit.

### CROSS-REFERENCE TO RELATED APPLICATION(S)

This application is based upon and claims the benefit of priority from: U.S. provisional application 61/265,818, filed on Dec. 2, 2009; the entire contents all of which are incorporated herein by reference.

### FIELD

Embodiments described herein relate to a technique of limiting various kinds of processing that is performed to image data acquired by an image processing apparatus scanning a document.

### BACKGROUND

Conventionally, image data acquired by an image processing apparatus scanning a document is stored in a predetermined storage area, and according to needs, various kinds of processing such as printing or transmission via email may be performed to the image data stored in the storage area.

The usage or the like of the image data stored in the storage area in this manner is usually not limited and many unspecified users can freely use the image data stored in the storage area. These circumstances pose problems in terms of ensuring security and protecting privacy.

### DESCRIPTION OF THE DRAWINGS

FIG. 1 is a perspective view of appearance showing the overall configuration of an image processing apparatus 1.

FIG. 2 is a functional block diagram for explaining the image processing apparatus 1.

FIG. 3 is a flowchart for explaining a flow of processing (processing limiting method) in the image processing apparatus 1.

FIG. 4 shows an exemplary data table that is referred to when placing limitation by a processing limiting unit 104.

FIG. 5 shows an exemplary data table that is referred to when placing limitation by the processing limiting unit 104.

FIG. 6 shows an exemplary data table that is referred to when placing limitation by the processing limiting unit 104.

FIG. 7 shows an exemplary data table that is referred to when placing limitation by the processing limiting unit 104.

### DETAILED DESCRIPTION

In general, according to an embodiment, an image processing apparatus includes an image scanning unit, a storage control unit, a limitation information associating unit, and a processing limiting unit.

The image scanning unit scans an image of a document.

The storage control unit causes image data acquired by the image scanning unit scanning the image to be stored in a predetermined storage area.

The limitation information associating unit associates limitation information prescribing a limitation content for a processing content to be performed to the image data with the image data that is stored in the predetermined storage area, based on at least one of an image scanning condition in the image scanning unit and a content of the image data acquired by the image scanning unit.

The processing limiting unit limits the content of processing performed to the image data stored in the predetermined storage area, based on the limitation information associated by the limitation information associating unit.

Hereinafter, an embodiment will be described with reference to the drawings.

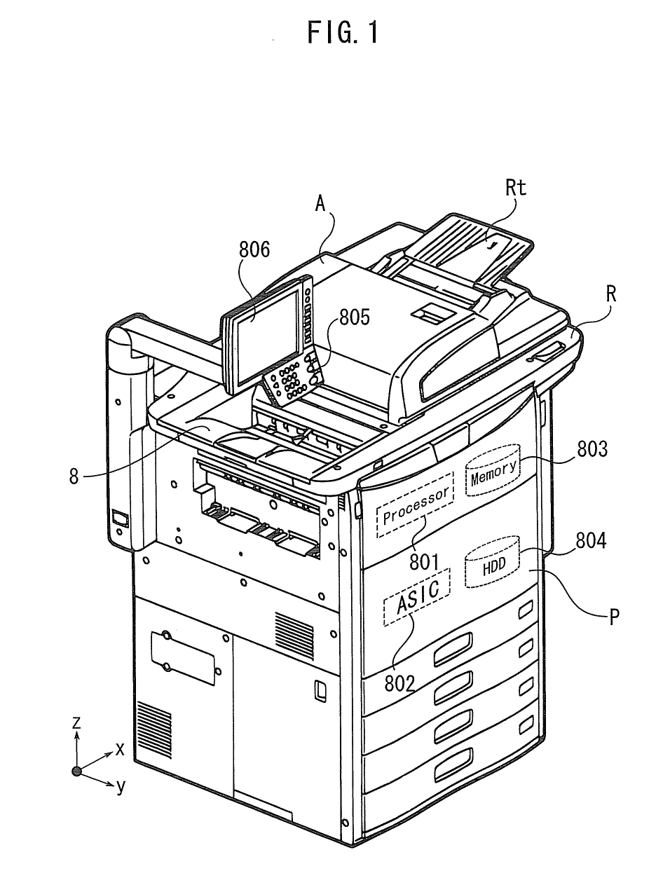

FIG. 1 is a perspective view of appearance showing the overall configuration of an image processing apparatus 1.

The image processing apparatus 1 has an automatic document feeder A, an image scanning unit R, an image forming unit P, and a discharge tray 8.

The automatic document feeder (ADF) A has the function of continuously automatically carrying a document including plural sheets placed on a tray Rt toward a predetermined document scanning position where the document is scanned by the image scanning unit R.

The image scanning unit R is arranged in an upper part of the body of the image processing apparatus and has the function of scanning and reading an image of the sheet document that is automatically carried by the automatic document feeder A or a sheet document or book document placed on a document placing table, not shown.

The image forming unit P has the function of forming a developer image on a sheet supplied from a paper supply cassette, based on the image scanned from the document by the image scanning unit R or image data or the like received by the image processing apparatus 1 from an external device.

The sheet on which the image is formed by the image forming unit P is discharged onto the discharge tray 8.

The image processing apparatus 1 also has a processor 801, an application specific integrated circuit (ASIC) 802, a memory 803, a hard disk drive (HDD) 804, an operation input unit 805, and a display unit 806.

The operation input unit 805 can include, for example a keyboard, mouse, touch panel, touchpad, graphics tablet, dedicated button or the like.

The display unit 806 can include, for example, an electronic paper, liquid crystal display (LCD), electronic luminescence (EL), plasma display panel (PDP), cathode ray tube (CRT) or the like.

Alternatively, a so-called touch panel display can realize the functions of the operation input unit 805 and the display unit 806.

In the image processing apparatus 1 according to this embodiment, the processor 801 plays the role of carrying out various kinds of processing in the image processing apparatus 1 and also plays the role of realizing various functions by executing programs stored in the memory 803, the HDD 804 and the like. As a matter of course, the processor 801 can be realized by a central processing unit (CPU) or micro processing unit (MPU) capable of executing equivalent arithmetic processing. Similarly, the HDD 804 can be replaced by a storage device, for example, a flash memory or the like.

The memory 803 can include, for example, a random access memory (RAM), read only memory (ROM), dynamic random access memory (DRAM), static random access memory (SRAM), video RAM (VRAM), flash memory or the like. The memory 803 plays the role of storing various kinds of information and programs used in the image processing apparatus 1.

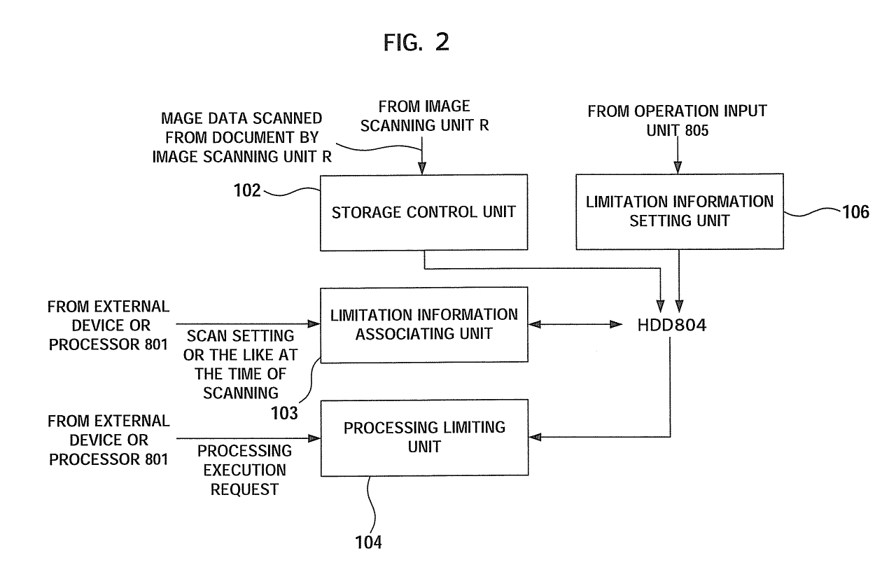

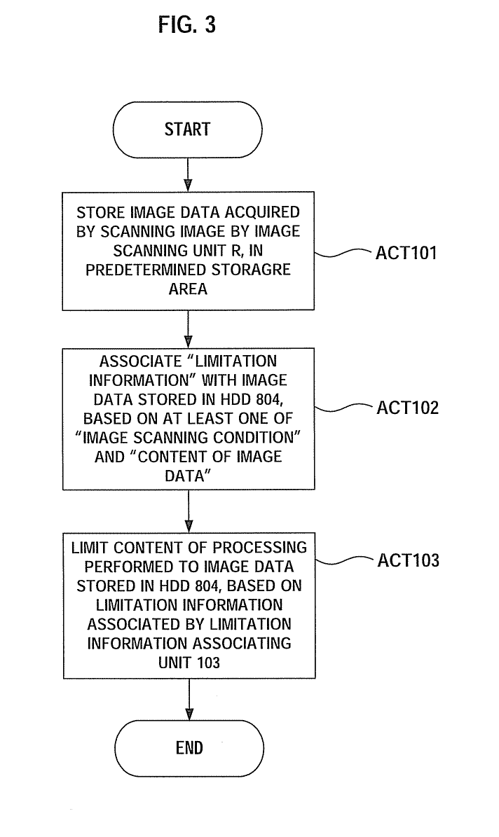

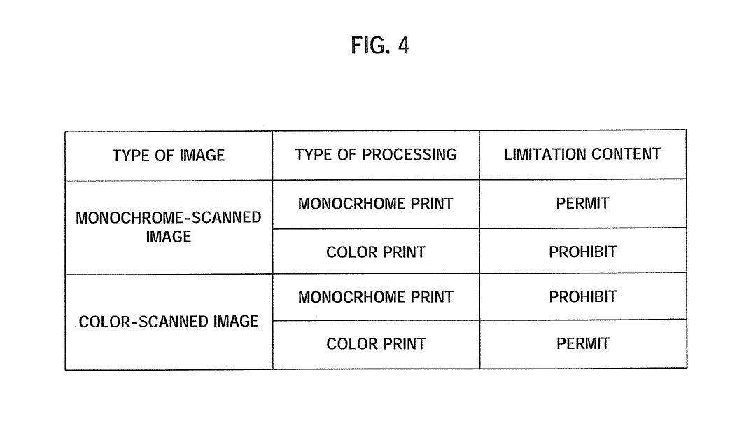

FIG. 2 is a functional block diagram for explaining the image processing apparatus 1. FIG. 3 is a flowchart for explaining a flow of processing (processing limiting method) in the image processing apparatus 1. FIG. 4 to FIG. 7 show examples of a data table that is referred to when placing limitation by a processing limiting unit 104, which will be described later.

As shown in FIG. 2, the image processing apparatus has, for example, a storage control unit 102, a limitation information associating unit 103, a processing limiting unit 104, and a limitation information setting unit 106.

Specifically, the storage control unit 102 causes image data acquired by the image scanning unit R scanning an image, to be stored in the HDD 804 (predetermined storage area) (ACT 101).

The limitation information associating unit 103 associates “limitation information” prescribing a limitation content for a content of processing performed to the image data with the image data stored in the HDD 804, based on at least one of “an image scanning condition in the image scanning unit R” and “the content of the image data acquired by the image scanning unit R” (ACT 102).

For example, with respect to image data that is color-scanned by the image scanning unit R (for example, full-color scan or the like), the limitation information associating unit 103 associates information that printing in other modes than a color mode is prohibited, with the color-scanned image data. FIG. 4 shows a rule table that prescribes that the limitation content on the processing should be changed according to whether the document scanning by the image scanning unit R is monochrome scanning or color scanning.

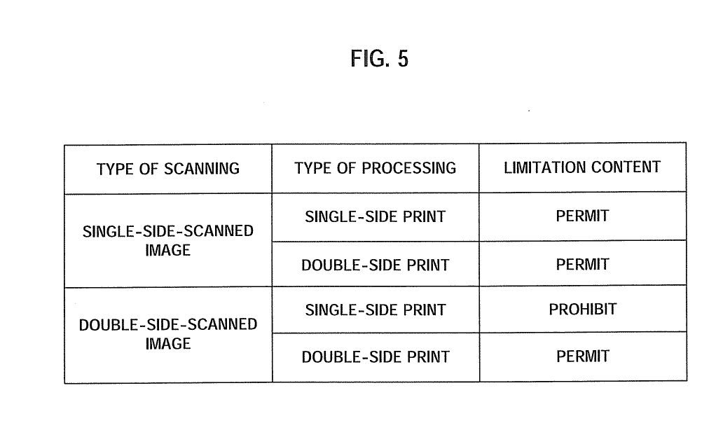

With respect to image data acquired by double-side scanning by the image scanning unit R, the limitation information associating unit 103 associates information that printing other than double-side print is prohibited, with the double-side-scanned image data. FIG. 5 shows a rule table that prescribes that the limitation content on the processing should be changed according to whether the document scanning by the image scanning unit R is double-side scan or single-side scan.

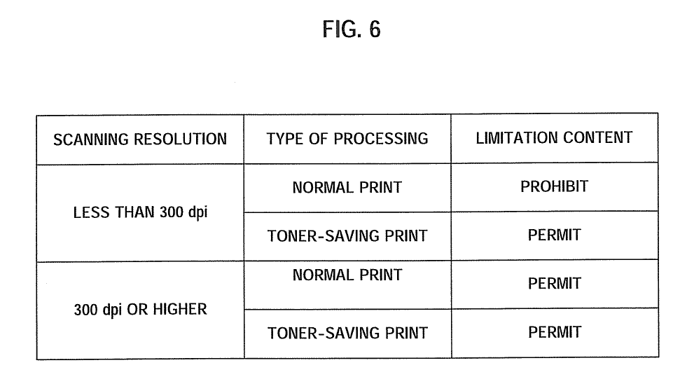

With respect to image data scanned with a resolution equal to or lower than a predetermined value by the image scanning unit R, the limitation information associating unit 103 associates information that printing in other modes than a predetermined print mode is prohibited, with the image data that is scanned with a resolution equal to or lower than the predetermined value . FIG. 6 shows a rule table that prescribes that the limitation content on the processing should be changed according to whether the document scanning by the image scanning unit R is carried out with a predetermined resolution or higher, or with a resolution less than the predetermined resolution.

The rule tables shown in FIG. 4 to FIG. 6 are stored, for example in the HDD 804. The limitation information associating unit 103 associates the limitation information with the image data, referring to these rule tables stored in the HDD 804.

The association of the limitation information by the limitation information associating unit 103 may be realized by writing the limitation information into the header or the like of the image data or may be realized by storing a correspondence table in a database or the like in the HDD 804 or an external device and then linking the limitation information with the image data.

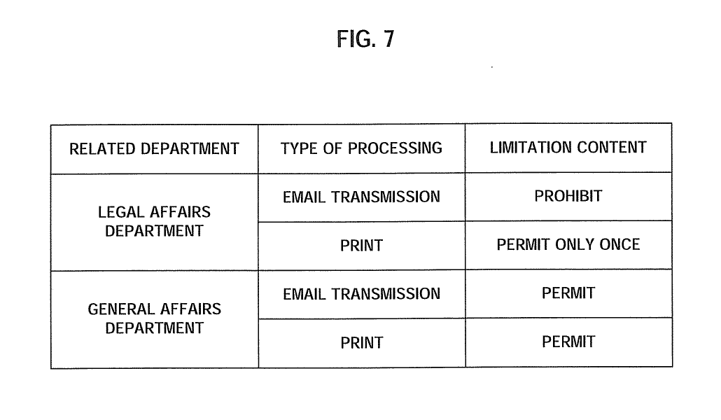

The limitations as shown in FIG. 4 to FIG. 6 can also be combined arbitrarily, as in the rule table shown in FIG. 7. In the example shown in FIG. 7, not only whether certain processing can be executed or not, but also the number of times the execution is permitted (the number of times of use) is prescribed. The number of times of execution in this case is counted, for example, by the processor 801. As the count value is accumulated as history in the HDD 804, the number of times of execution can be determined.

The processing limiting unit 104 limits the content of processing performed to the image data stored in the HDD 804, based on the limitation information associated by the limitation information associating unit 103.

The limitation information setting unit 106 sets the content of limitation information associated with image data, based on an operation input accepted by the operation input unit 805.

Here, the content of “limitation information” set by the limitation information setting unit 106 can include, for example, the number of times of execution of predetermined processing that can be executed to the image data stored in the HDD 804.

In this case, the processing limiting unit 104 limits the number of times of execution of the predetermined processing that is performed to the image data stored in the HDD 804, based on the limitation information associated by the limitation information associating unit 103 (see FIG. 7).

In the above examples, the usage of image data to be limited includes email transmission, print, monochrome print, color print, single-side print, double-side print and the like. However, the usage of image data to be limited is not limited to these examples.

As a matter of course, execution limitation may also be placed on editing and alteration of the content of image data.

The rules shown in FIG. 4 to FIG. 7 can be set according to various standards, for example, for each image processing apparatus (MFP: Multi Function Peripheral), for each usage, for each department, for each user, or for each data content.

Thus, for example, it is possible to place limitation that “print of image data that is scanned by the image processing apparatus installed in the accounting department is permitted only once”.

When the number of times of execution of processing to certain image data (the number of times of use) exceeds the number of times that is prescribed in the rule table, the processing limiting unit 104 can place, for example, the following processing limitation:

(1) automatically delete the image data;

(2) notify the user that the prescribed number of times is exceeded; and

(3) end the execution of the processing as error.

Each operation in the processing in the image processing apparatus 1 is realized by causing the processor 801 to execute a processing limitation program stored in the memory 803.

In the above embodiment, the case where the “predetermined storage area” is in the HDD 804 provided in the image processing apparatus 1 is described. However, the predetermined storage area is not limited to this example. As a matter of course, for example, a storage area in a storage device such as an HDD provided in an external device such as a server device that can communicate with the image processing apparatus 1 can also be used.

Moreover, the program that causes the computer constituting the image processing apparatus to execute each of the above operations can be provided as an image processing program. In the embodiment, the case where the program for realizing the functions to carry out the invention is recorded in advance in the storage area provided within the apparatus is described. However, the acquisition of the program is not limited to this example. A similar program may be downloaded to the apparatus from a network or a similar program stored in the computer-readable recording medium may be installed in the apparatus . The recording medium may be in any form as long as the recording medium can store the program and can be read by a computer. Specifically, the recording medium may be, for example, an internal storage device that is internally provided in the computer, such as ROM or RAM, a portable storage medium such as CD-ROM, flexible disk, DVD disk, magneto-optical disk or IC card, a database which holds a computer program, another computer and its database, or a transmission medium on a communication line. The functions that can be installed or downloaded in advance in this manner can also be realized in cooperation with the operating system (OS) or the like within the apparatus.

A part of the program or the entire program may be in the form of execution modules that are dynamically generated.

As a matter of course, at least a part of the various kinds of processing realized by the execution of the program by the processor in the embodiments can be executed via circuitry of the ASIC 802.

As described above in detail, according to the technology described in this specification, a technique can be provided that enables proper limitation on the content of processing performed to image data scanned from a document according to the content of the image scanning.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image processing apparatus comprising:
an image scanning unit which scans an image of a document;
a storage control unit which causes image data acquired by the image scanning unit scanning the image to be stored in a predetermined storage area;
a limitation information associating unit which associates limitation information prescribing a limitation content for a processing content to be performed to the image data with the image data that is stored in the predetermined storage area, based on at least one of an image scanning condition in the image scanning unit and a content of the image data acquired by the image scanning unit; and
a processing limiting unit which limits the content of processing performed to the image data stored in the predetermined storage area, based on the limitation information associated by the limitation information associating unit.

2. The apparatus of claim 1, further comprising:
an operation input unit which accepts a user's operation input; and
a limitation information setting unit which sets a content of the limitation information associated with the image data, based on the operation input accepted by the operation input unit.

3. The apparatus of claim 1, wherein with respect to image data that is color-scanned by the image scanning unit, the limitation information associating unit associates information that printing in other modes than a color mode is prohibited, with the color-scanned image data.

4. The apparatus of claim 1, wherein with respect to image data that is double-side-scanned by the image scanning unit, the limitation information associating unit associates information that printing other than double-side print is prohibited, with the double-side-scanned image data.

5. The apparatus of claim 1, wherein with respect to image data scanned with a resolution equal to or lower than a predetermined value by the image scanning unit, the limitation information associating unit associates information that printing in other modes than a predetermined print mode is prohibited, with the image data that is scanned with a resolution equal to or lower than the predetermined value.

6. The apparatus of claim 2, wherein the content of the limitation information set by the limitation information setting unit is the number of times of execution of predetermined processing that can be executed to the image data stored in the predetermined storage area, and
the processing limiting unit limits the number of times of execution of the predetermined processing performed to the image data stored in the predetermined storage area, based on the limitation information associated by the limitation information associating unit.

7. The apparatus of claim 1, wherein the predetermined storage area is a storage area in a storage device provided in the image processing apparatus.

8. A processing limiting method comprising:
scanning an image of a document;
storing image data acquired by scanning the image of the document, in a predetermined storage area;
associating limitation information prescribing a limitation content for a processing content to be performed to the image data with the image data that is stored in the predetermined storage area, based on at least one of an image scanning condition at the time of scanning the image and a content of the image data acquired by scanning the image of the document; and
limiting the content of processing performed to the image data stored in the predetermined storage area, based on the associated limitation information.

9. The method of claim 8, wherein a content of the limitation information associated with the image data is set based on an operation input from a user.

10. The method of claim 8, wherein with respect to image data that is color-scanned, information that printing in other modes than a color mode is prohibited is associated with the color-scanned image data.

11. The method of claim 8, wherein with respect to image data that is double-side-scanned, information that printing other than double-side print is prohibited is associated with the double-side-scanned image data.

12. The method of claim 8, wherein with respect to image data scanned with a resolution equal to or lower than a predetermined value, information that printing in other modes than a predetermined print mode is prohibited is associated with the image data that is scanned with a resolution equal to or lower than the predetermined value.

13. The method of claim 9, wherein the content of the limitation information that is set is the number of times of execution of predetermined processing that can be executed to the image data stored in the predetermined storage area, and
the number of times of execution of the predetermined processing performed to the image data stored in the predetermined storage area is limited based on the limitation information that is associated.

14. The method of claim 8, wherein the predetermined storage area is a storage area in a storage device provided in an image processing apparatus.
